(19) United States
(12) Patent Application Publication
(10) Pub. No.: US 2013/0280119 A1
(43) Pub. Date: Oct. 24, 2013

(54) MAGNETIC MATERIAL AND METHOD FOR PRODUCING THE SAME

(71) Applicants: Kousaku Okamura, Shiga (JP); Kazuhiko Madokoro, Shiga (JP)

(72) Inventors: Kousaku Okamura, Shiga (JP); Kazuhiko Madokoro, Shiga (JP)

(73) Assignee: DAIHATSU MOTOR CO., LTD., Osaka (JP)

(21) Appl. No.: 13/820,903

(22) PCT Filed: Aug. 29, 2011
(86) PCT No.: PCT/JP11/69494

§ 371 Date: Mar. 5, 2013

(30) Foreign Application Priority Data
Sep. 6, 2010 (JP) 2010-199013
Sep. 17, 2010 (JP) 2010-208717
Jun. 24, 2011 (JP) 2011-141006

(51) Int. Cl. H01F 1/01; H01F 41/02

(52) U.S. Cl. CPC H01F 1/01; H01F 41/0246
USPC 419/38; 148/304

(57) ABSTRACT

A magnetic material is produced by mixing a magnet powder with an amorphous metal containing a rare-earth element, iron, and boron, the rare-earth element being in the range of 22 to 44 atomic %, and the boron being in the range of 6 to 28 atomic %; and heating the mixture to a temperature or more, the temperature being lower than the crystallization temperature of the amorphous metal by 30° C., or when the amorphous metal is a metallic glass, to a temperature of the glass transition temperature thereof or more.

### TECHNICAL FIELD

The present invention relates to a magnetic material and a method for producing the same.

### BACKGROUND ART

A sintered magnet having a Nd—Fe—B composition has been known conventionally (hereinafter referred to as Nd—Fe—B sintered magnet) as a magnet having high magnetic properties.

Such a magnet can be produced, for example, by subjecting a magnet powder to magnetic field pressing to orientate the magnet powder to improve magnetic properties, and thereafter, subjecting the magnet powder to sintering.

To be more specific, for example, Patent Document 1 (Example 1) below has proposed a method for producing a high electric resistance rare-earth permanent magnet, in which an anisotropic magnet powder having a composition of Nd_{12.5}Fe_{bal}Co_{17.5}B_{6.6}Ga_{0.2}Zr_{0.1}Si_{0.1} is kneaded with paraffin hydrocarbon, and furthermore, the magnet powder is mixed with CaF₂ (insulator with high electric resistance). After molding the mixture in a magnetic field, the obtained compact is subjected to debindering, and placed into a graphite mold for spark plasma sintering, to be subjected to spark plasma sintering.

Meanwhile, it has been known that such a Nd—Fe—B sintered magnet usually contains, to improve heat-resistance, a heavy rare-earth such as Dy, which is a scarce resource; however, nowadays, in view of the dwindling resource, a magnet that does not require blending of a heavy rare-earth such as Dy has been demanded as a substitute for the Nd—Fe—B sintered magnet.

As such a magnet, a nitrogen magnet (e.g., a magnet having a composition of Sm—Fe—N, etc.) has been proposed. A nitrogen magnet is high in potential, and has excellent magnetic properties, but is thermally unstable; therefore, sintering may cause decomposition of the component of the nitrogen magnet, and magnetic properties may be reduced.

Thus, for example, Patent Document 2 below has proposed a resin bonded magnet obtained by blending epoxy resin in a weight ratio of 3% (based on powder) relative to Sm₂Fe₁₇N_{2.6} compound powder, and applying a pressure of 8 ton/cm² thereto to perform compression molding.

### CITATION LIST

### Patent Document

Patent Document 1
Japanese Unexamined Patent Publication No. H10-163055

Patent Document 2
Japanese Unexamined Patent Publication No. H4-346203

### SUMMARY OF THE INVENTION

### Problem to be Solved by the Invention

However, with the production method of the high electric resistance rare-earth permanent magnet as the one described in Patent Document 1, the mixture of the anisotropic magnet powder and the insulator has to be sintered at high temperature, and therefore after press molding the magnet powder in a magnetic field, when subjecting the magnet powder to spark plasma sintering, the compact has to be transferred from the mold for press molding to a graphite mold for spark plasma sintering.

Therefore, in such a method for producing a high electric resistance rare-earth permanent magnet, handling is troublesome, and furthermore, at the time of transferring, the compact may be damaged.

In this regard, sintering of the compact without transferring the compact has also been considered, for example, use of a graphite mold for spark plasma sintering for the magnetic field pressing process has been considered. However, because the strength of the graphite mold for spark plasma sintering is not sufficient, use of the graphite mold for spark plasma sintering in the magnetic field pressing process may cause damage to the mold.

Furthermore, to suppress the damage to the mold, it has been also considered that the magnet is orientated by a low pressure magnetic field pressing. In such a case, the pressure for pressing is insufficient, and therefore orientation of the magnet may be destroyed at the time of sintering.

Meanwhile, for example, the following method has also been considered: a magnetic field pressing apparatus including a sintering device is used, and in the magnetic field pressing apparatus, the magnetic field pressing and sintering are performed using the same mold. However, in such a case, the magnet may not be appropriately orientated due to the effect of heat, and furthermore, there is a disadvantage in that the size of the apparatus increases.

Furthermore, the resin bonded magnet described in Patent Document 2 contains epoxy resin, and therefore the compact itself can be formed densely, but the density of the magnet component itself cannot be improved, and therefore there is a disadvantage in that sufficient magnetic properties cannot be obtained.

An object of the present invention is to provide a magnetic material that can be produced easily and has excellent magnetic properties; and a method for producing a magnetic material that allows for reliable production of a magnetic material having excellent magnetic properties with easy operation.

### Means for Solving the Problem

To achieve the above object, the magnetic material of the present invention is a magnetic material in which a magnet powder and an amorphous metal are used as ingredients, wherein the amorphous metal contains a rare-earth element, iron, and boron;
the amorphous metal contains the rare-earth element in the range of 22 to 44 atomic %, and the boron in the range of 6 to 28 atomic %; and
the magnetic material is obtained by mixing the magnet powder and the amorphous metal, and heating the mixture to a temperature or more, the temperature being lower by 30° C. than the crystallization temperature (Tx) of the amorphous metal, or when the amorphous metal is a metallic glass, heating the mixture to a temperature of the glass transition temperature (Tg) thereof or more.

In the magnetic material of the present invention, it is preferable that the amorphous metal further contains cobalt, and in the amorphous metal, the atomic ratio of the cobalt to iron is 1.5 or less.

It is preferable that the magnetic material of the present invention further contains an additive, and the additive content relative to 100 parts by mass of the magnetic material is below 10 parts by mass.

In the magnetic material of the present invention, it is preferable that a magnetic anisotropic magnet powder is used as the magnet powder, and a mixture of the magnetic anisotropic magnet powder with the amorphous metal is subjected to magnetic field pressing.

A method for producing a magnetic material of the present invention includes:
mixing a magnet powder with an amorphous metal having an initial softening temperature of 600° C. or less, thereby producing a powder mixture;
charging the powder mixture to a mold, and pressure molding the powder mixture in a magnetic field, thereby producing a compact; and
subjecting the compact to spark plasma sintering in the same mold, thereby heating the compact to a temperature of the initial softening temperature or more of the amorphous metal.

### Effect of the Invention

The magnetic material of the present invention can be produced easily and can ensure excellent magnetic properties.

Furthermore, with the method for producing a magnetic material of the present invention, because the amorphous metal has an initial softening temperature of 600° C. or less, a low sintering temperature can be used in the spark plasma sintering. Therefore, after pressure molding the magnet powder and the amorphous metal in a mold in a magnetic field, the compact can be subjected to spark plasma sintering in the same mold without transferring the compact to a high heat-resistance mold.

Thus, the method for producing a magnetic material of the present invention achieves and ensures production of a magnetic material having excellent magnetic properties with easy operation.

### EMBODIMENT OF THE INVENTION

A magnetic material of the present invention uses a magnet powder and an amorphous metal as ingredients. Examples of the magnet powder include, for example, a nitrogen magnet powder (hereinafter referred to as nitrogen magnet), and a nitrogen nanocomposite magnet powder (hereinafter referred to as nitrogen nanocomposite magnet).

In the present invention, the nitrogen magnet is not particularly limited, and examples thereof include a rare-earth-transition metal-nitrogen magnet, and a transition metal-nitrogen magnet.

Examples of the rare-earth-transition metal-nitrogen magnet include a Sm—Fe—N magnet and a Sm—Fe—Mn—N magnet, and preferably, a Sm—Fe—N magnet is used.

The Sm—Fe—N magnet is powder of magnet (hereinafter may be referred to as SmFeN) having a Sm—Fe—N based composition, and can be produced by grinding, for example, SmFeN obtained by a known method.

To be more specific, for example, first, SmFe alloy powder is produced from samarium oxide and iron powder by reduction-diffusion, and the obtained SmFe alloy powder is heated, for example, under the atmosphere of N₂ gas, NH₃ gas, or a mixture of N₂ and H₂ gases, for example, at a temperature of 600° C. or less, thereby producing SmFeN.

Thereafter, the obtained SmFeN is finely ground, for example, by a known grinder such as a jet mill and a ball mill. The Sm—Fe—N magnet can be obtained in this manner.

The Sm—Fe—N magnet can also be produced without grinding SmFeN. In this method, for example, first, Sm and Fe are dissolved in acid, and Sm ion and Fe ion are obtained. Thereafter, for example, an anion (e.g., hydroxide ion, carbonate ion, etc.) that reacts with Sm ion and Fe ion to form insoluble salt is added to the solution, thereby producing a salt precipitate.

Thereafter, the obtained precipitate is baked, thereby producing metal oxide, and thereafter, subjecting the metal oxide to reduction treatment. The Sm—Fe—N magnet can be obtained in this manner.

The Sm—Fe—N magnet can be produced by a method other than the above-described method, and can be produced by another known method.

Examples of the Sm—Fe—N magnet include, to be more specific, Sm₂Fe₁₇N₃ (Curie point: 474° C.).

Examples of the transition metal-nitrogen magnet include Fe—N magnet, and preferably, Fe₁₆N₂ magnet is used.

These nitrogen magnets may be used singly or in a combination of two or more.

The nitrogen magnet has a decomposition temperature of, for example, 600° C. or more. Furthermore, such a nitride magnet decomposes by heating, for example, gradually from 500° C., to form SmN and Fe.

The nitrogen magnet (powder) has a volume average particle size of, for example, 1 to 20 μm, preferably 2 to 4 μm.

When the nitrogen magnet (powder) has a volume average particle size within the above-described range, coercive force will be excellent.

For the nitrogen magnet (powder), commercially available one can be used, and for example, Z16 (Sm—Fe—N magnet (Sm₂Fe₁₇N₃), decomposition temperature 600° C., volume average particle size 3 pin, manufactured by Nichia Corporation) may be used.

In the present invention, the nitrogen nanocomposite magnet is not particularly limited, and examples thereof include a Sm—Fe—N nanocomposite magnet.

The Sm—Fe—N nanocomposite magnet is, for example, a powder of nanocomposite magnet having a Fe/Sm—Fe—N-based structure, and without particular limitation, for example, can be produced by applying an electric current and a pressure to a Sm—Fe—N magnet.

To be more specific, in this method, for example, a predetermined pressure is applied to a Sm—Fe—N magnet obtained by a known method using a spark plasma sintering device, and also the Sm—Fe—N magnet is subjected to pulse currents for a predetermined time. This allows a partial decomposition of the Sm—Fe—N magnet, and a Fe crystal phase can be formed as a soft magnetic field in a Sm—Fe—N single crystal phase as a high magnetic field. The Sm—Fe—N based nanocomposite magnet can be produced in this manner. The Sm—Fe—N based nanocomposite magnet can be used, as necessary, by further grinding.

The Sm—Fe—N based nanocomposite magnet can also be made, without limitation to the above-described method, by another known method.

Examples of the Sm—Fe—N based nanocomposite magnet include, to be more specific, a nanocomposite magnet of Fe and Sm₂Fe₁₇N₃ (Curie point: 474° C.).

These nitrogen nanocomposite magnets may be used singly or in a combination of two or more.

Generally, when a nitrogen nanocomposite magnet is baked in the production of magnetic materials, its crystal undergoes coarsening, reducing the coercive force.

The crystal of the nitrogen nanocomposite magnet undergoes coarsening at a temperature of, for example, 600° C. or more.

The nitrogen nanocomposite magnet (powder) has a volume average particle size of, for example, 30 to 300 μm, preferably 50 to 150 μm.

When the nitrogen nanocomposite magnet (powder) has a volume average particle size within the above-described range, the packing factor of the magnetic powder improves, and remanence becomes excellent.

These magnet powders are classified into a magnetic isotropic magnet powder and a magnetic anisotropic magnet powder.

The magnetic isotropic magnet powder is defined as follows: individual alloy powder grain is composed of a large number of fine crystal grains, and the direction of easy axis of magnetization of individual crystal grains is disorderly.

The magnetic anisotropic magnet powder is defined as follows: individual alloy powder grain is a single crystal, or composed of a large number of fine crystal grains, and the direction of easy axis of magnetization of individual crystal grain is all along a specific direction.

These magnetic isotropic magnet powder and magnetic anisotropic magnet powder can be produced by a known method.

These magnet powders may be used singly or in a combination of two or more.

The magnet powder is not particularly limited. When a magnetic isotropic magnet powder is used, excellent magnetic properties can be ensured without performing magnetic field pressing described later, and furthermore, when a magnetic anisotropic magnet powder is used, in view of improving magnetic properties of the obtained magnetic material, preferably, magnetic field pressing is performed to be described later.

In the present invention, the amorphous metal is an amorphous alloy that starts to deform (soften) at a temperature below the crystallization temperature (Tx), and has excellent magnetic properties. Such an amorphous metal starts to deform (soften) by heating, and thereafter, crystallized.

In the present invention, the amorphous metal contains a rare-earth element, Fe (iron and B (boron).

Such an amorphous metal contains the rare-earth element to cause crystal magnetic anisotropy in the baking, and to improve the magnetic properties (e.g., coercive force, etc.).

Examples of the rare-earth element include light rare-earth elements such as Sc (scandium), Y (yttrium), La (lanthanum), Ce (cerium), Pr (praseodymium), Nd (neodymium), Pm (promethium), Sm (samarium), and Eu (europium); and heavy rare-earth elements such as Gd (gadolinium), Tb (terbium), Dy (dysprosium), Ho (holmium), Er (erbium), Tm (thulium), Yb (ytterbium), and Lu (lutetium).

These rare-earth elements may be used singly or in a combination of two or more.

Such an amorphous metal can realize a sufficiently large coercive force without necessarily containing a heavy rare-earth element.

As the rare-earth element, preferably, a light rare-earth element, and more preferably, Nd (neodymium) is used.

When Nd (neodymium) is used as the rare-earth element, the coercive force and remanent magnetization of the magnetic material obtained by using the amorphous metal can be improved.

The amorphous metal has, in the range of 22 to 44 atomic %, preferably 23 to 40 atomic %, more preferably 24 to 37 atomic % of the rare-earth element (when used in combination, a total thereof).

When the rare-earth element atomic percent is below the above-described lower limit, the crystallization temperature (Tx) of the amorphous metal may become high, and therefore as described later, when the magnet powder and the amorphous metal are heat-treated to produce a magnetic material, there are disadvantages: the energy costs in the heat treatment increase, and furthermore, workability and productivity decrease.

When the rare-earth element atomic percent is below the above-described lower limit, there is a disadvantage in that the coercive force of the magnetic material decreases.

Meanwhile, when the rare-earth element atomic percent is more than the above-described upper limit, there is a disadvantage in that the remanent magnetization of the magnetic material decreases.

When the rare-earth element atomic percent is more than the above-described upper limit, there is a disadvantage in that the material is costly and easily oxidized, and therefore is less productive and safe.

In contrast, when the rare-earth element atomic percent is in the above-described range, the remanent magnetization and coercive force of the magnetic material obtained by using amorphous metal can be improved, and furthermore, the crystallization temperature (Tx) of the amorphous metal can be kept low. Therefore, as described later, without heat treatment at high temperature, a magnetic material can be produced at low costs, and with excellent workability and productivity.

In the amorphous metal, Fe (iron) is an element that contributes to magnetism, and is contained to improve magnetic properties (e.g., remanence, etc.) of the magnetic material.

The amorphous metal has an Fe (iron) atomic percent of, for example, in the range of 15 to 65 atomic %, preferably 20 to 60 atomic %, more preferably 25 to 55 atomic %.

When the Fe (iron) atomic percent is below the above-described lower limit, the remanence after heat treatment (crystallization) described later of the magnetic material may be reduced.

When the Fe (iron) atomic percent is more than the above-described upper limit, the coercive force of the magnetic material after heat treatment (crystallization) described later may be reduced.

The amorphous metal contains B (boron) to form an amorphous phase, and to form an amorphous alloy.

The amorphous metal has a B (boron) atomic percent in the range of 6 to 28 atomic %, preferably 12 to 28 atomic %, more preferably 15 to 25 atomic %.

When the B (boron) atomic percent is below the above-described lower limit, at the time of quenching described later, a crystal phase may be generated, and in the case where a compact is produced using an amorphous metal as an ingredient by, for example, spark plasma sintering or hot pressing, moldability and processability may be reduced.

When the B (boron) atomic percent is more than the above-described upper limit, the remanence after heat treatment (crystallization) described later of the magnetic material may be reduced.

The amorphous metal preferably contains Co (cobalt).

The amorphous metal contains Co (cobalt) to improve magnetic properties of the magnetic material obtained by using an amorphous metal, and in an attempt to improve handleability by preventing oxidation.

Furthermore, when the amorphous metal is a metallic glass as described later, Co (cobalt) is contained to stabilize the metallic glass described later in the softened state (glass transition state), and to improve moldability.

The amorphous metal has a Co (cobalt) atomic percent of, for example, in the range of 1 to 50 atomic %, preferably 2 to 45 atomic %, more preferably 4 to 40 atomic %.

When the Co (cobalt) atomic percent is below the above-described lower limit, handleability, moldability, and processability may be reduced.

In particular, when the amorphous metal is a metallic glass as described later, the supercooling region (region of glass transition temperature or more and below crystallization temperature. ΔTx (=Tx−Tg)) cannot be ensured sufficiently, and moldability and processability may be reduced.

When the Co (cobalt) atomic percent is more than the above-described upper limit, the remanence of the magnetic material obtained by using the amorphous metal may be reduced.

The atomic ratio of Co (cobalt) to Fe (iron) is preferably 1.5 or less, preferably 1.44 or less, and more preferably 0.6 or less.

When the atomic ratio of Co (cobalt) to Fe (iron) is 1.5 or less, handleability can be improved. On the other hand, when the atomic ratio of Co (cobalt) to Fe (iron) is more than 1.5, there is a disadvantage in terms of costs.

The amorphous metal may further contain various other elements as additional elements, including, for example, transition elements such as Ti (titanium), Zr (zirconium), Hf (hafnium), V (vanadium), Nb (niobium), Ta (tantalum), Cr (chromium), Mo (molybdenum), W (tungsten), Mn (manganese), Ni (nickel), Cu (copper), Ru (ruthenium), Rh (rhodium), Pd (palladium), Ag (silver), Os (osmium), Jr (iridium), Pt (platinum), and Au (gold); and main group elements including, for example, C (carbon), P (phosphorus), Al (aluminum), Si (silicon), Ca (calcium), Ga (gallium), Ge (germanium), Sn (tin), Pb (lead), and Zn (zinc).

These additional elements may be used singly or in a combination of two or more.

Examples of preferable additional elements are Ti (titanium), Zr (zirconium), Nb (niobium), Cr (chromium), Ni (nickel), Cu (copper), Si (silicon), and Al (aluminum).

When at least one selected from the group consisting of Ti (titanium), Zr (zirconium), Nb (niobium), Cr (chromium), Ni (nickel), Cu (copper), Si (silicon), and Al (aluminum) is contained as the additional element, the remanence and coercive force of the magnetic material can be improved.

Such an amorphous metal has an additional element atomic percent of, for example, 1 to 15 atomic %, preferably 1 to 10 atomic %, more preferably 1 to 5 atomic %.

More preferably, Al (aluminum) is used as the additional element.

When the amorphous metal contains Al (aluminum) as the additional element, the crystallization temperature (Tx) of the amorphous metal to be described later can be kept low, and therefore as described later, the magnetic material can be produced without performing heat treatment at high temperature, that is, at low costs, and with excellent workability and productivity.

When the amorphous metal is a metallic glass to be described later, the initial softening temperature (deformation start temperature, glass transition temperature (Tg)) of the metallic glass can be kept low, and therefore further improvement in moldability can be achieved.

In the case where the amorphous metal contains Al (aluminum), the Al (aluminum) atomic percent is, for example, below 15 atomic %, preferably below 5 atomic %, more preferably 3.5 atomic % or less, and more preferably 3 atomic % or less.

When the Al (aluminum) atomic percent is 5 atomic % or more, the crystallization temperature (Tx) of the amorphous metal becomes high, and may increase costs for magnetic material production, and may reduce workability and productivity.

The amorphous metal has a rare-earth element and Fe (iron) (also Co (cobalt) contained as necessary) atomic percent in total of, for example, 65 to 94 atomic %, preferably 70 to 90 atomic %, more preferably 72 to 85 atomic %.

When the rare-earth element and Fe (iron) (also Co (cobalt) contained as necessary) atomic percent in total is within the above-described range, moldability and processability of the amorphous metal can be improved, and furthermore, remanence and coercive force of the magnetic material after heat treatment (crystallization) described later can be made excellent.

The amorphous metal has an atomic percent in total of elements other than the rare-earth element and Fe (iron) (also Co (cobalt) contained as necessary) (including B (boron) as an essential component, and including additional elements (e.g., Ti (titanium), Zr (zirconium), Nb (niobium), Cr (chromium), Ni (nickel), Cu (copper), Si (silicon), and Al (aluminum) as optional components), is, for example, in the range of 6 atomic % or more, preferably 10 to 30 atomic %, more preferably 15 to 28 atomic %, particularly preferably 15 to 25 atomic %.

When the atomic percent in total of the elements other than the rare-earth element, Fe (iron), and Co (cobalt) is within the above-described range, moldability and processability of the amorphous metal can be improved, and furthermore, the remanence and coercive force of the magnetic material after heat treatment (crystallization) described later can be made excellent.

An example of an embodiment of such an amorphous metal include an amorphous metal represented by formula (I) below.

R₈₃₋ₓFe_{x/2}Co_{x/2}Al_{17-y}B_{y} (1)

(where R represents a rare-earth element, 0<x<83, and 0<y≦17.)

In formula (I) above, R represents the above-described rare-earth element (the same applies to the following).

The range of x is 0<x<83, preferably 28<x<58, and more preferably 33<x<53.

When the value of x is within the above-described range, moldability and processability of the amorphous metal can be improved, and furthermore, the remanence and coercive force of the magnetic material after heat treatment (crystallization) described later can be made excellent.

The range of y is 0<y≦17, preferably 12<y<17, and more preferably 13.5<y<17.

When the value of y is within the above-described range, moldability and processability of the amorphous metal can be improved, and furthermore, the remanence and coercive force of the magnetic material after heat treatment (crystallization) described later can be made excellent.

Such an amorphous metal is not particularly limited, and can be produced by a known method.

To be more specific, for example, first, powder, or block (as necessary, may be partially alloyed) of the above-described elements is prepared as an ingredient component, and these are mixed to have the above-described atomic percent.

Then, the obtained mixture of the ingredient components are melted under an atmosphere of inert gas (e.g., nitrogen gas, argon gas, etc.).

The method for melting the ingredient components is not particularly limited, as long as the above-described elements can be dissolved, and for example, arc melting can be used.

Then, for example, the ingredient components are cooled, thereby producing a block alloy (ingot) containing the above-described elements at the above-described atomic percent. Thereafter, the obtained block alloy is ground by a known method, thereby producing a particulate alloy (particle size: 0.5 to 20 mm).

Thereafter, in this method, the obtained particulate alloy is dissolved, thereby producing a molten alloy.

The method for dissolving the particulate alloy is not particularly limited, as long as the above-described particulate alloy can be dissolved, and for example, high-frequency induction heating can be used.

Next, in this method, the obtained molten alloy is quenched by a known method, for example, by single roll method, or gas atomizing process, thereby producing an amorphous metal.

In the single roll method, for example, the molten alloy is allowed to fall on the peripheral surface of the revolving chill roll, and the molten alloy and the chill roll are brought into contact for a predetermined time period, thereby quenching the molten alloy.

The molten alloy is quenched at a rate (cooling speed) of, for example, 10⁻² to 10³° C./s.

The rate of the quenching (cooling speed) of the molten alloy can be controlled, for example, by adjusting the revolving speed of the chill roll. In such a case, the revolving speed of the chill roll is, for example, 1 to 60 m/s, preferably 20 to 50 m/s, more preferably 30 to 40 m/s.

By quenching the molten alloy in such a manner, for example, a belt-form (including a thin film and a thick film) amorphous metal can be obtained on the peripheral surface of the chill roll.

The obtained amorphous metal has thickness of, for example, 1 to 500 μm, preferably 5 to 300 μm, more preferably 10 to 100 μm.

In the gas atomizing process, for example, a high-pressure gas (e.g., helium gas, argon gas, nitrogen gas, etc.) spray is applied over to the molten alloy to quench and at the same time finely grinding the above-described molten alloy.

By quenching the molten alloy in this manner, a powdered amorphous metal can be obtained.

The obtained amorphous metal has a volume average particle size of, for example, 1 to 200 μm, preferably 5 to 50 μm.

The method for quenching the molten alloy is not limited to the above-described single roll method and the gas atomizing process, and a known method can be applied. Preferably, the single roll method is used.

The crystallization temperature (Tx) of the amorphous metal (temperature at which crystallization is started) is, for example, 600° C. or less, preferably 550° C. or less, more preferably 500° C. or less.

The crystallization temperature (Tx) of the amorphous metal can be measured by DSC (differential scanning calorimetry), and in the present invention, the crystallization temperature (Tx) is defined as a value measured at a rate of temperature increase of 40° C./min.

When a plurality of the crystallization temperatures (Tx) are observed, the lowest crystallization temperature (Tx) of the crystallization temperatures (Tx) obtained is regarded as the crystallization temperature (Tx) of the amorphous metal.

The thus obtained amorphous metal contains metallic glass.

The metallic glass is an amorphous alloy having a glass transition temperature (Tg) of below the crystallization temperature (Tx), and has high moldability.

When the thus obtained amorphous metal is metallic glass, the initial softening temperature (deformation start temperature, glass transition temperature (Tg)) is, for example, 600° C. or less, preferably 500° C. or less, more preferably 450° C. or less.

The amorphous metal may be softened by heating even if the amorphous metal is not metallic glass, and in such a case, the initial softening temperature is, for example, 600° C. or less, preferably 500° C. or less, more preferably 450° C. or less.

The initial softening temperature of the amorphous metal (including metallic glass) can be measured, for example, by DSC (differential scanning calorimetry) or by press displacement measurement of a spark plasma sintering device.

These amorphous metals may be used singly or in a combination of two or more.

The magnetic material of the present invention may further contain an additive.

Examples of the additive include a transition element and a main group element having a melting point of 600° C. or less, and a compound having a melting point adjusted to 600° C. or less. To be specific, examples of additives include a transition element and a main group element such as Zn, Sn, Bi, Cd, In, Li, P, Na, S, and Te; a binary compound such as an Ag—Al alloy, an Ag—Sn alloy, an Ag—Zn alloy, an Al—Au alloy, an Al—Cu alloy, an Al—Si alloy, an Al—Sn alloy, an Al—Zn alloy, an Au—Mg alloy, an Au—Sn alloy, a Cu—In alloy, a Cu—Mg alloy, a Cu—Sn alloy, a Cu—Zn alloy, a Cu-rare-earth alloy, a Co—Zn alloy, a Fe—Zn alloy, a Mg—Zn alloy, a Ni—Zn alloy, and a Sn—Zn alloy; and a plural compound having a melting point of 600° C. or less.

These additives may be used singly or in a combination of two or more.

As the additive, preferably, Zn (zinc) is used.

The additive has a volume average particle size of, for example, 5 nm to 100 μm, preferably 20 nm to 10 μm.

In the magnetic material, the additive content relative to 100 parts by mass of the magnetic material is, for example, below 10 parts by mass, preferably 5 parts by mass or less.

In the present invention, to produce the magnetic material, first, the magnet powder and the amorphous metal (and as necessary an additive to be blended) are mixed.

The mixing ratio of the magnet powder and the amorphous metal relative to 100 parts by mass of the total of the magnet powder and the amorphous metal is as follows: for example, 60 to 99 parts by mass, preferably, 80 to 95 parts by mass of the magnet powder; and for example, 1 to 40 parts by mass, preferably 5 to 20 parts by mass of the amorphous metal.

When the additive is blended, the mixing ratio of the additive is adjusted so that the additive content of the magnetic material is within the above-described range.

The mixing is not particularly limited, as long as the magnet powder and the amorphous metal (and also as necessary, the additive to be blended) are sufficiently mixed, for example, a known mixer such as a ball mill may be used.

In this method, both of the dry mixing, and wet mixing may be used. For example, in dry mixing, the magnet powder and the amorphous metal (and an additive blended as necessary) are mixed under an inert gas (e.g., nitrogen gas, argon gas, etc.) atmosphere. In wet mixing, the magnet powder and the amorphous metal (and an additive blended as necessary) are mixed in a solvent (e.g., cyclohexane, acetone, ethanol, etc.).

The mixing conditions are not particularly limited, and when a ball mill (content 0.30 is used, the number of revolution is, for example, 100 to 300 rpm, preferably 150 to 250 rpm, and the mixing time is, for example, 5 to 60 min, preferably 5 to 45 minutes.

Next, in this method, a mixture of the magnet powder and the amorphous metal (and an additive blended as necessary) is heated, for example, while applying pressure, to a temperature or more, the temperature being lower than the crystallization temperature (Tx) of the amorphous metal by 30° C.

When the amorphous metal is metallic glass, a mixture of the magnet powder and the amorphous metal (and an additive blended as necessary) can also be heated, for example, while applying pressure, to a temperature of the glass transition temperature (Tg) thereof or more.

To be more specific, in this method, for example, by using a hot pressing device or spark plasma sintering device, a mixture of the magnet powder and the amorphous metal (and an additive blended as necessary) is heated, for example, under a pressure condition of, 20 to 1500 MPa, preferably 200 to 1000 MPa, to a temperature or more, the temperature being lower than the crystallization temperature (Tx) of the amorphous metal by 30° C.; or when the amorphous metal is metallic glass, to its glass transition temperature (Tg) or more, preferably the crystallization temperature (Tx) of the amorphous metal or more, to be specific, for example, 400 to 600° C., preferably 410 to 550° C.

With such a molding under pressure and heat, the amorphous metal is deformed, and in this manner, a high density magnetic material can be obtained. Furthermore, the amorphous metal is a hard magnetic phase, and therefore a magnetic material containing a magnet powder and a hard magnetic phase generated from the amorphous metal can be obtained.

The heating is not particularly limited, and for example, can be performed at a predetermined rate of temperature increase from normal temperature. In such a case, the rate of temperature increase is, for example, 10 to 200° C./min, preferably 20 to 100° C./min.

In the production of a magnetic material, as necessary, by using, for example, an image furnace, after the above-described molding under pressure and heat, the compact of a magnet powder, and the amorphous metal or a hard magnetic phase generated from the amorphous metal can also be kept for a predetermined time period under a high temperature condition.

In such a case, after the above-described heat treatment, the compact can be kept, for example, at 400 to 600° C., preferably 410 to 550° C., for example, for 1 to 120 min, preferably, 10 to 60 min.

In this manner, the crystallization heat treatment process of the amorphous metal can be performed in batches, and therefore productivity of magnetic materials can be improved.

Furthermore, in the production of a magnetic material, after the temperature increase in molding under pressure and heat, as necessary, the compact can be kept under pressure and heat.

Furthermore, in the production of a magnetic material, for example, the above-described molding under pressure and heat, and heat treatment thereafter can be performed in a magnetic field.

Also, as a pretreatment for the above-described molding under pressure and heat, a pressure may be applied to a mixture of the magnet powder and the amorphous metal (and as necessary an additive) in the magnetic field (magnetic field pressing).

In particular, when a magnetic anisotropic magnet powder is used as the magnet powder, preferably, a mixture of the magnet powder and the amorphous metal is subjected to the magnetic field pressing.

When a pressure is applied in the magnetic field, the magnet powder can be orientated toward a predetermined direction, and therefore magnetic properties of the obtained magnetic material can be further improved.

The conditions for the magnetic field pressing are, for example, as follows: a magnetic field to be applied of 10 kOe or more, preferably 20 kOe or more; and a pressure of, for example, 30 to 2000 MPa, preferably 100 to 1000 MPa.

In the thus obtained magnetic material, material deterioration caused by baking of the magnet powder is suppressed, to be more specific, generation of SmN and Fe by decomposition of nitrogen magnet, and coarsening of the crystal of nitrogen nanocomposite magnet are suppressed, and at the same time, an amorphous metal having excellent magnetic properties is charged between the gaps (voids) of the magnet powder grains.

Thus, with such a magnetic material, excellent magnetic properties can be ensured with simple production.

Therefore, compared with a resin bonded magnet containing resin (e.g., epoxy resin, etc.), the magnetic material can improve the magnetic properties.

In such a magnetic material, the amorphous metal has a rare-earth element atomic percent in the range of 22 to 44 atomic %, a boron atomic percent in the range of 6 to 28 atomic %, and therefore a magnetic material can be produced without heat treatment at high temperature, that is, at low costs, and with excellent workability and productivity.

That is, an amorphous metal (e.g., Nd₆₀Fe₃₀Al₁₀, etc.) excluding the above-described composition can be used as the amorphous metal, but such an amorphous metal has insufficient magnetic properties, and therefore magnetic properties of the obtained magnetic material may be poor.

On the other hand, the magnetic material of the present invention is produced by mixing the above-described amorphous metal and the magnet powder, and heating the mixture to a temperature of the initial softening temperature or more of the amorphous metal, and therefore excellent magnetic properties can be achieved.

In addition to the above-described method, for example, the magnetic material can be produced by using an amorphous metal having an initial softening temperature of 600° C. or less, and after pressure molding the powder mixture of the above-described magnet powder and the amorphous metal in a magnetic field, subjecting the mixture to spark plasma sintering.

In the following, the method for producing a magnetic material is described in detail.

To be specific, in the method for producing a magnetic material, first, in the same manner as described above, a magnet powder, and an amorphous metal having an initial softening temperature of 600° C. or less (and also as necessary the above-described additive (the same applied to the following)) are mixed, thereby producing a powder mixture.

Next, in this method, powder mixture of the magnet powder and the amorphous metal is charged in a mold, and at the same time, pressure molded (magnetic field pressing) in a magnetic field, thereby producing a compact.

Examples of the mold include, for example, a cemented carbide-made mold.

Cemented carbide is a composite material produced by sintering a carbide (e.g., WC (tungsten carbide), etc.) of metal atoms of fourth to sixth group of Periodic Table of the Elements (in accordance with IUPAC Periodic Table of the Elements (version date 22 Jun. 2007)) with, for example, iron-based metals such as Fe (iron), Co (cobalt), and Ni (nickel).

As the cemented carbide, in view of orientation of the magnet powder in magnetic field pressing, preferably, Ni-bonded alloy is used.

Examples of the Ni-bonded alloy include, to be more specific, a WC—Ni (tungsten carbide-nickel) based-alloy and a WC—Ni—Cr (tungsten carbide-nickel-chromium) based-alloy.

Examples of the cemented carbide further include other cemented carbides, to be more specific, iron-bonded alloys such as a WC—Fe (tungsten carbide-iron) based-alloy; and Co-bonded alloys such as a WC—Co (tungsten carbide-cobalt) based-alloy, a WC—TiC—Co (tungsten carbide-titanium carbide-cobalt) based-alloy, a WC—TaC—Co (tungsten carbide-tantalum carbide-cobalt) based-alloy, and a WC—TiC—TaC—Co (tungsten carbide-titanium carbide-tantalum carbide-cobalt) based-alloy.

Conditions in the magnetic field pressing are as follows: a magnetic field to be applied of 10 kOe or more, preferably 20 kOe or more, and a pressure of, for example, 30 to 2000 MPa, preferably 100 to 1000 MPa.

When a pressure is applied to the powder mixture in a magnetic field, the magnet powder can be orientated toward a predetermined direction, and therefore magnetic properties of the obtained magnetic material can be further improved.

Next, in this method, the obtained compact is subjected to spark plasma sintering in the above-described mold, that is, the same mold used in the magnetic field pressing.

In spark plasma sintering, compact composed of a mixture of magnet powder and amorphous metal is heated (heat treatment) under a pressure condition of, for example, 20 to 1500 MPa, preferably 200 to 1000 MPa, at a temperature higher than the initial softening temperature of the amorphous metal, by, for example, 0 to 200° C., preferably 10 to 150° C., to be specific, to 400 to 600° C., preferably 410 to 500° C.

The magnetic material containing magnet powder and amorphous metal can be obtained in this manner.

The heating is not particularly limited, and for example, can be carried out from normal temperature with a predetermined rate of temperature increase. In such a case, the rate of temperature increase is, for example, 10 to 200° C./rain, preferably 20 to 100° C./min.

In the production of a magnetic material, as necessary, continuously from the above-described heat treatment, the mixture of magnet powder and amorphous metal can also be kept for a predetermined time period under a high temperature condition.

In such a case, after the above-described heat treatment, the mixture can be kept, for example, at 400 to 600° C., preferably 410 to 500° C., for example, for 1 to 120 min, preferably 10 to 60 min.

In this manner, magnetic properties of the obtained magnetic material can be further improved.

Furthermore, in the production of the magnetic material, at the time of heating (heat treatment), as necessary, pressure molding can also be performed, and in such a case, the molding pressure condition is, for example, 30 to 2000 MPa, preferably 100 to 1000 MPa, more preferably 200 to 800 MPa.

Furthermore, in the production of the magnetic material, for example, the above-described pressure molding can be performed in a magnetic field.

In the thus obtained magnetic material, material deterioration caused by baking of the magnet powder is suppressed, to be more specific, generation of SmN and Fe by decomposition of nitrogen magnet, and coarsening of the crystal of nanocomposite magnet are suppressed, and at the same time, an amorphous metal having excellent magnetic properties is charged between the gaps (voids) of the magnet powder grains.

Thus, with such a magnetic material, excellent magnetic properties can be ensured with simple production.

With such a method for producing a magnetic material, the initial softening temperature of amorphous metal is 600° C. or less, and therefore the sintering temperature in spark plasma sintering can be made low. Thus, after the magnet powder and amorphous metal are pressure molded in a mold in a magnetic field, the compact can be subjected to spark plasma sintering in the same mold without transferring the compact to a high heat-resistance mold.

Thus, with the method for producing a magnetic material, a magnetic material having excellent magnetic properties can be produced with a simple operation.

### EXAMPLES

In the following, the present invention will be described based on Examples and Comparative Examples, but the present invention is not limited to Examples below.

### Production Examples 1 to 8

### Production of Amorphous Metal

Elements of Nd (neodymium), Fe (iron), Co (cobalt), Al (aluminum), and B (boron) in the form of powder or block are formulated in accordance with the mixing ratio that forms the compositions shown in Table 1, and melted using an arc melting furnace under an atmosphere of Ar (argon) at 4 kPa (30 Torr), thereby producing alloys (ingot) having composition percentage shown in Table 1.

Then, the obtained ingot was ground, thereby producing a particulate alloy (particle size: 0.5 to 10 mm).

Thereafter, the obtained particulate alloy is melted by high frequency induction heating under an atmosphere of Ar to produce a molten alloy, and then the obtained molten alloy was quenched under an atmosphere of Ar by allowing the obtained molten alloy to fall on the peripheral surface of a chill roll of a circumferential speed of 40 m/s using a single roll device. The amorphous metal was obtained in this manner.

Thereafter, the obtained amorphous metal was finely ground using a planetary ball mill (LP-1 manufactured by Ito Seisakusho Co., Ltd.) to give a volume average particle size of 1.5 μm.

### Production Example 9

### Production of Amorphous Metal

Nd₆₀Fe₃₀Al₁₀ was produced by gas atomizing process (spraying gas: Ar), and then finely ground by ball mill (manufactured by Ito Seisakusho Co., Ltd. LP-1) thereafter. Nd₆₀Fe₃₀Al₁₀ powder having a volume average particle size of 1 μm was obtained in this manner.

### [Evaluation]

Using a DSC (differential scanning calorimetry: manufactured by SII Inc., DSC6300), the crystallization temperature (Tx) of the amorphous metal obtained in Production Examples, and when the amorphous metal is metallic glass, the glass transition temperature (Tg) were measured.

To be specific, 10 mg of an amorphous metal sample was introduced into an alumina pan, and measured under an Ar atmosphere at a rate of temperature increase of 40° C./min.

When a plurality of crystallization reactions (Tx) were observed, the lower of the temperatures was regarded as the crystallization temperature (Tx).

When the crystallization temperature (Tx) and the glass transition temperature (Tg) were observed, the supercooling region ΔTx (=Tx—Tg) was calculated.

The results are shown in Table 1.

TABLE 1

| | | | | | | | Evaluation | | |
|---|---|---|---|---|---|---|---|---|---|
| | Blending | | | | | | Glass Transition | Crystallization | Supercooling |
| Production | Formulation(atomic %) | | | | | Co/ | Temperature | Temperature | Region |
| Example No. | Nd | Fe | Co | B | Al | Fe | Tg(° C.) | Tx(° C.) | [symbol] Tx(° C.) |
| Production Ex. 1 | 33.0 | 25.0 | 25.0 | 17.0 | — | 1.0 | 419 | 433 | 14 |
| Production Ex. 2 | 33.0 | 25.0 | 19.0 | 23.0 | — | 0.8 | 417 | 432 | 15 |
| Production Ex. 3 | 33.0 | 25.0 | 25.0 | 12.0 | 5.0 | 1.0 | — | 434 | — |
| Production Ex. 4 | 35.6 | 43.1 | 4.3 | 17.0 | — | 0.1 | 433 | 448 | 15 |
| Production Ex. 5 | 24.0 | 26.5 | 26.5 | 23.0 | — | 1.0 | — | 449 | — |
| Production Ex. 6 | 37.7 | 45.7 | 4.6 | 12.0 | — | 0.1 | 428 | 434 | 16 |
| Production Ex. 7 | 33.0 | 44.0 | — | 23.0 | — | 0.0 | 441 | 465 | 24 |
| Production Ex. 8 | 33.0 | 18.0 | 26.0 | 23.0 | — | 1.4 | 359 | 392 | 33 |
| Production Ex. 9 | 60.0 | 30.0 | — | — | 10.0 | — | — | 506 | — |

### Example 1

Amorphous metal powder obtained in Production Example 1, and Z16 (magnetic anisotropic magnet powder, Sm—Fe—N magnet (Sm₂Fe₁₇N₃), decomposition temperature 600° C., volume average particle size 3 μm, manufactured by Nichia Corporation) were blended so that the amorphous metal is 10 mass % relative to the total of the amorphous metal powder and Z16, and mixed in cyclohexane by Attritor (FILMIX® Model 40-40, manufactured by PRIMIX Corporation) at a circumferential speed of 40 m/s for 5 minutes.

Then, the mixture was dried under nitrogen atmosphere, thereby producing a powder mixture of amorphous metal powder and magnet powder.

Thereafter, 1.0 g of the powder mixture was taken out, and charged in a nonmagnetic mold (manufactured by Hokkai M.I.C., sleeve and punch material: nonmagnetic cemented carbide (WC—Ni based-alloy), die material: HPM75, molding size: 8 mm×6 mm), and subjected to magnetic field pressing using a magnetic field pressing device (model TM-MPH8525-10T manufactured by Tamakawa Co., Ltd.), with a magnetic field of 25 kOe, at a pressing pressure of 800 MPa.

Subsequently, in the same mold, using a spark plasma sintering device (SPS-515S manufactured by SPS Sintex Inc.), a pressure was applied in vacuum to 800 MPa, and the mixture was heated (increased temperature) at a rate of temperature increase of 40° C./min to 440° C., and allowed to stand for 30 min, and thereafter cooled. The magnetic material was obtained in this manner without causing damage to nonmagnetic mold.

### Examples 2 to 22 and Comparative Examples 1 to 8

A magnetic material was obtained in the same manner as in Example 1, except that magnet powder Z16, or SP14 (magnetic isotropic magnet powder, isotropic Sm—Fe—N magnet used for production of bonded magnet SP-14 (manufactured by DAIDO ELECTRONICS CO., LTD.)), and the amorphous metal obtained in Production Examples were blended at the mixing ratio shown in Table 2, and spark plasma sintering was performed under the treatment conditions shown in Table 2.

The magnetic field pressing was not performed except for Example 1 and Comparative Example 8.

TABLE 2

| | | | Mixing Ratio | | Spark Plasma Sintering | | | |
|---|---|---|---|---|---|---|---|---|
| Ex. and | Materials Used | | (parts by mass) | | Conditions | | | Magnetic |
| Comp. | Magnet | | Magnet | Amorphous | Temperature | Time | Pressure | Field Pressing |
| Ex. No. | Powder | AmorphousMetal | Powder | Metal | (° C.) | (mm) | (MPa) | Treatment |
| Ex. 1 | Z16 | Production Ex. 1 | 90 | 10 | 440 | 30 | 800 | Performed |
| Ex. 2 | | | 90 | 10 | 420 | 30 | 800 | Not Performed |
| Ex. 3 | | | 90 | 10 | 440 | 30 | 800 | Not Performed |
| Ex. 4 | | | 90 | 10 | 460 | 30 | 800 | Not Performed |
| Ex. 5 | Z16 | Production Ex. 2 | 95 | 5 | 440 | 30 | 800 | Not Performed |
| Ex. 6 | | | 90 | 10 | 440 | 30 | 800 | Not Performed |
| Ex. 7 | | | 85 | 15 | 440 | 30 | 800 | Not Performed |
| Ex. 8 | Z16 | Production Ex.3 | 95 | 5 | 440 | 30 | 800 | Not Performed |
| Ex. 9 | | | 90 | 10 | 440 | 30 | 800 | Not Performed |
| Ex. 10 | | | 85 | 15 | 440 | 30 | 800 | Not Performed |
| Ex. 11 | | | 90 | 10 | 440 | 10 | 800 | Not Performed |
| Ex. 12 | Z16 | Production Ex. 1 | 90 | 10 | 440 | 30 | 1000 | Not Performed |
| Ex. 13 | Z16 | Production Ex. 4 | 90 | 10 | 460 | 30 | 800 | Not Performed |
| Ex. 14 | | | 85 | 15 | 460 | 30 | 800 | Not Performed |
| Ex. 15 | | | 90 | 10 | 460 | 30 | 1000 | Not Performed |
| Ex. 16 | Z16 | Production Ex. 5 | 90 | 10 | 460 | 30 | 1000 | Not Performed |
| Ex. 17 | Z16 | Production Ex. 6 | 90 | 10 | 460 | 30 | 1000 | Not Performed |
| Ex. 18 | SP14 | Production Ex. 2 | 90 | 10 | 440 | 10 | 600 | Not Performed |
| Ex. 19 | SP14 | Production Ex. 2 | 90 | 10 | 440 | 10 | 800 | Not Performed |
| Ex. 20 | Z16 | Production Ex. 7 | 90 | 10 | 460 | 30 | 800 | Not Performed |
| Ex. 21 | Z16 | Production Ex. 8 | 90 | 10 | 460 | 30 | 800 | Not Performed |
| Ex. 22 | Z16 | Production Ex. 5 | 90 | 10 | 419 | 30 | 1000 | Not Performed |
| Comp. | Z16 | Not Used | 100 | 0 | 440 | 10 | 800 | Not Performed |
| Ex. 1 | | | | | | | | |
| Comp. | Z16 | Not Used | 100 | 0 | 440 | 0 | 800 | Not Performed |
| Ex. 2 | | | | | | | | |
| Comp. | Z16 | Not Used | 100 | 0 | 440 | 30 | 800 | Not Performed |
| Ex. 3 | | | | | | | | |
| Comp. | Z16 | Not Used | 100 | 0 | 420 | 0 | 800 | Not Performed |
| Ex. 4 | | | | | | | | |
| Comp. | Z16 | Production Ex. 8 | 90 | 10 | 460 | 30 | 800 | Not Performed |
| Ex. 5 | | | | | | | | |
| Comp. | Z16 | | 90 | 10 | 420 | 0 | 800 | Not Performed |
| Ex. 6 | | | | | | | | |
| Comp. | Z16 | | 90 | 10 | 420 | 30 | 800 | Not Performed |
| Ex. 7 | | | | | | | | |
| Comp. | Z16 | Not Used | 100 | 0 | 440 | 30 | 800 | Performed |
| Ex. 8 | | | | | | | | |

### Examples 23 to 27

Magnet powder Z16, and the amorphous metal obtained in Production Example 1, and an additive Zn (volume average particle size 30 nm) were blended at the mixing ratio shown in Table 3, and mixed in a mortar, thereby producing a powder mixture of the amorphous metal powder, magnet powder, and additive.

Thereafter, 0.3 g of the powder mixture was taken out, and charged in a cemented carbide mold (molding size: 5 mm×5 mm). The powder mixture was heated (increased temperature) under vacuum under a pressure shown in Table 3 to the temperature shown in Table 3 using a spark plasma sintering device (SPS-515S manufactured by SPS Sintex Inc.), and allowed to stand at the temperature for the time shown in Table 3, and then thereafter cooled. The magnetic material was obtained in this manner.

TABLE 3

| | | | | Mixing Ratio | | | Spark Plasma Sintering | | | |
|---|---|---|---|---|---|---|---|---|---|---|
| | Materials Used | | | (parts by mass) | | | Conditions | | | Magnetic |
| | Magnet | Amorphous | | Magnet | Amorphous | | Temperature | Time | Pressure | Field Pressing |
| Ex. No. | Powder | Metal | Additive | Powder | Metal | Additive | (° C.) | (min) | (MPa) | Treatment |
| Ex. 23 | Z16 | Production | Zn | 85 | 10 | 5 | 440 | 30 | 1000 | Not |
| | | Ex. 1 | | | | | | | | Performed |
| Ex. 24 | Z16 | Production | Zn | 85 | 10 | 5 | 440 | 20 | 1000 | Not |
| | | Ex. 1 | | | | | | | | Performed |
| Ex. 25 | Z16 | Production | Zn | 85 | 10 | 5 | 440 | 10 | 1000 | Not |
| | | Ex. 1 | | | | | | | | Performed |
| Ex. 26 | Z16 | Production | Zn | 85 | 10 | 5 | 440 | 0 | 1000 | Not |
| | | Ex. 1 | | | | | | | | Performed |
| Ex. 27 | Z16 | Production | Zn | 86 | 11 | 3 | 440 | 0 | 1000 | Not |
| | | Ex. 1 | | | | | | | | Performed |

Evaluation

Magnetic materials obtained in Examples and Comparative Examples were measured for demagnetization curve using VSM (manufactured by Tamakawa Co., Ltd.), and their magnetic properties were evaluated. The results are shown in Tables 4 and 5.

TABLE 4

| | Rema- | B Coercive | I Coercive | Maximum Energy |
|---|---|---|---|---|
| | nence | force | force | Product |
| Ex. and | Br | bHc | iHc | (BH)max |
| Comp. Ex. No. | (T) | (kA/m) | (kA/m) | (kJ/m³) |
| Ex. 1 | 0.9872 | 430.4 | 508.0 | 143.7 |
| Ex. 2 | 0.5512 | 325.4 | 665.8 | 47.7 |
| Ex. 3 | 0.5563 | 325.7 | 667.4 | 47.8 |
| Ex. 4 | 0.5618 | 320.3 | 647.9 | 47.5 |
| Ex. 5 | 0.5713 | 255.2 | 415.2 | 41.1 |
| Ex. 6 | 0.5543 | 293.5 | 536.2 | 43.8 |
| Ex. 7 | 0.5282 | 294.6 | 601.4 | 40.9 |
| Ex. 8 | 0.5612 | 233.6 | 378.8 | 34.9 |
| Ex. 9 | 0.5568 | 260.1 | 451.1 | 39.0 |
| Ex. 10 | 0.5396 | 273.0 | 522.6 | 38.2 |
| Ex. 11 | 0.5482 | 264.2 | 462.2 | 39.2 |
| Ex. 12 | 0.5949 | 326.9 | 633.4 | 51.2 |
| Ex. 13 | 0.5322 | 249.7 | 451.2 | 34.9 |
| Ex. 14 | 0.5200 | 245.6 | 454.3 | 33.3 |
| Ex. 15 | 0.5452 | 244.4 | 435.0 | 34.4 |
| Ex. 16 | 0.5325 | 254.6 | 484.9 | 35.1 |
| Ex. 17 | 0.5450 | 256.6 | 456.7 | 36.6 |
| Ex. 18 | 0.9596 | 468.0 | 613.9 | 118.3 |
| Ex. 19 | 0.8575 | 417.0 | 607.3 | 90.5 |
| Ex. 20 | 0.5383 | 245.5 | 449.4 | 34.0 |
| Ex. 21 | 0.5621 | 323.3 | 661.0 | 47.6 |
| Ex. 22 | 0.5162 | 247.8 | 459.3 | 32.9 |
| Comp. Ex. 1 | 0.5422 | 199.8 | 317.0 | 28.3 |
| Comp. Ex. 2 | 0.5432 | 198.3 | 307.8 | 29.1 |
| Comp. Ex. 3 | 0.5350 | 185.0 | 286.3 | 26.0 |
| Comp. Ex. 4 | 0.5354 | 182.3 | 268.6 | 26.9 |
| Comp. Ex. 5 | 0.4933 | 217.3 | 381.7 | 27.8 |
| Comp. Ex. 6 | 0.4834 | 213.1 | 347.7 | 28.4 |
| Comp. Ex. 7 | 0.5015 | 220.9 | 383.5 | 29.1 |
| Comp. Ex. 8 | 0.8440 | 384.6 | 439.6 | 106.3 |

TABLE 5

| | | B Coercive | I Coercive | Maximum Energy |
|---|---|---|---|---|
| | Remanence | Force | Force | Product |
| | Br | BHc | iHc | (BH)max |
| Ex. No | (T) | (kA/m) | (kA/m) | (kJ/m³) |
| Ex. 23 | 0.5253 | 313.8 | 787.2 | 41.3 |
| Ex. 24 | 0.5051 | 293.4 | 775.1 | 37.0 |
| Ex. 25 | 0.5131 | 298.5 | 738.5 | 38.5 |
| Ex. 26 | 0.5361 | 315.2 | 687.2 | 44.0 |
| Ex. 27 | 0.5500 | 321.9 | 672.5 | 46.4 |

In Tables, Br represents remanence, bHc represents coercive farce (B coercive force), iHc represents coercive force (I coercive force), and (BH) max represents maximum energy product.

Higher the values of these are, the more excellent the magnetic properties are.

While the illustrative embodiments of the present invention are provided in the above description, such is for illustrative purpose only and it is not to be construed as limiting the scope of the present invention. Modifications and variations of the present invention that will be obvious to those skilled in the art are to be covered by the following claims.

### INDUSTRIAL APPLICABILITY

The magnetic material of the present invention is suitably used, for example, in driving motors of hybrid automobiles and electric vehicles, and in motors embedded in various machinery and materials such as compressors of air conditioners.

1. A magnetic material in which a magnet powder and an amorphous metal are used as ingredients,
wherein the amorphous metal contains a rare-earth element, iron, and boron;
the amorphous metal contains the rare-earth element in the range of 22 to 44 atomic %, and the boron in the range of 6 to 28 atomic %; and
the magnetic material is obtained by
mixing the magnet powder and the amorphous metal, and
heating the mixture to a temperature or more, the temperature being lower than the crystallization temperature (Tx) of the amorphous metal by 30° C., or
when the amorphous metal is a metallic glass, heating the mixture to a temperature of the glass transition temperature (Tg) thereof or more.

2. The magnetic material according to claim 1, wherein
the amorphous metal further contains cobalt, and in the amorphous metal, the atomic ratio of the cobalt to iron is 1.5 or less.

3. The magnetic material according to claim 1, further containing an additive,
and the additive content relative to 100 parts by mass of the magnetic material is below 10 parts by mass.

4. The magnetic material according to claim 1, wherein
a magnetic anisotropic magnet powder is used as the magnet powder, and a mixture of the magnetic anisotropic magnet powder with the amorphous metal is subjected to magnetic field pressing.

5. A method for producing a magnetic material comprising:
mixing a magnet powder with an amorphous metal having an initial softening temperature of 600° C. or less, thereby producing a powder mixture;
charging the powder mixture to a mold, and pressure molding the powder mixture in a magnetic field, thereby producing a compact, and
subjecting the compact to spark plasma sintering in the same mold, thereby heating the compact to a temperature of the initial softening temperature or more of the amorphous metal.
